(19) United States
(12) Patent Application Publication
(10) Pub. No.: US 2025/0366444 A1
(43) Pub. Date: Dec. 4, 2025

(54) TROLLEY FOR ANIMAL HUSBANDRY

(71) Applicant: Groupe Ro-Main Inc., St. Lambert-de-Lauzon (CA)

(72) Inventors: Robert Labrecque, St. Lambert-de-Lauzon (CA); Ghyslain Labrecque, St. Lambert-de-Lauzon (CA)

(21) Appl. No.: 18/731,919

(22) Filed: Jun. 3, 2024

(51) Int. Cl. A01K 29/00; B62B 5/00

(52) U.S. Cl. CPC A01K 29/00; B62B 5/0036; B62B 2202/42

(57) ABSTRACT

A trolley for use in animal husbandry includes a trolley frame carried on two pairs of wheels and extending to a rear handle for guiding the trolley. A cradle extends longitudinally of the frame for receiving a deceased animal puled onto the cradle over a front edge by a winch. The trolley is pivotal on the front pair of wheels between a loading position, in which the front edge is in contact with the floor, a rear portion of the cradle extends vertically to the handle and the rear wheels are raised, and a the transport position, in which the transverse front edge is raised from the floor surface, the rear wheels are in contact with the floor and a front planar portion of the cradle extends horizontally rearwardly from the front edge over the front pair of wheels to the rear pair of wheels to be stably supported by both the front and rear wheels.

This invention relates to a trolley for use in animal husbandry which includes a cradle extending longitudinally of the trolley frame from a rear end adjacent the handle to a forward end including a transverse front edge over which a dead animal can slide for storage on the cradle which pulled by a winch. The trolley specifically designed and sized for use with pigs and particularly finisher pigs which typically weigh around 200 lbs, but could be used for other animals.

Many examples of trolleys or carts which can be used to collect and carry a dead animal in a husbandry barn are known.

Simple two-wheel carts are known for example in U.S. Pat. No. 5,029,884 issued Jul. 9, 1991 where a bottom platform is provided at the floor and an upstanding channel receives the animal winched upwards toward an upper handle. The cart is picoted rearwardly and the load carried on the two wheels while guided and supported by the user at the rear handle. This type of cart is dedicated to its use for removing the dead animal and is otherwise unwieldy and difficult to wheel around a barn and unstable when released.

Simple four-wheel carts which are thus more stable when standing are available. Examples are shown in U.S. Pat. No. 8,100,430 issued Jan. 24 2012 and in U.S. Pat. No. 10,507,855 issued December 2019 where there are two additional wheels behind the main front wheels. In many cases these wheels need to steer or caster. In most cases the wheels are retractable or adjustable. The arrangement of the wheels does not provide a stable cart which can be easily pushed and is stable when released. Also the location of the load or dead animal on the receptacle relative to the wheels does not provide a stable location of the load requiring careful maneuvering by the operator to prevent toppling.

### SUMMARY OF THE INVENTION

According to the invention there is provided a trolley for use in animal husbandry comprising:
a trolley frame;
four wheels connected to the frame for supporting the frame from a floor surface for movement in a direction longitudinally of the frame, the four wheels including a front pair of wheels rotatable about a front axis and a rear pair of wheels rotatable about a rear axis;
a rear handle which is manually graspable for guiding the trolley;
a cradle on the frame for receiving a body of a deceased animal;
the cradle extending longitudinally of the trolley frame from a rear end adjacent the handle to a forward end including a transverse front edge over which the body can slide for storage on the cradle;
the cradle including a front portion extending rearwardly from the front edge over the first and second pairs of wheels;
the cradle including a rear portion extending upwardly and rearwardly from the front portion to the rear end adjacent the rear handle;
a winch at or adjacent the rear end for pulling an elongate flexible member for attachment to the animal to pull the animal onto the cradle;
the trolley frame and cradle being pivotal on the front pair of wheels about the front axis from a loading position to a transport position;
wherein, in the loading position, the transverse front edge is in contact with the floor surface for sliding movement of the animal over the front edge and the rear pair of wheels are raised from the floor surface;
wherein, in the transport position, the transverse front edge is raised from the floor surface, the rear pair of wheels are in contact with the floor surface and the front portion extends rearwardly from the front edge over the front pair of wheels to the rear pair of wheels to be stably supported by both the front and rear pairs of wheels.

This provides a cart which is simple to push and maneuver and can retain its stability when released by the operator both when unloaded and when loaded. In this way the heavy load of the dead animal can be readily carried to a discharge location while passing over changes in floor level at ramps and the like. Also the cart and be readily managed when unloaded and thus can act as for a transport for tools and the like and can be transported with the operator when moving around the barn.

In order to provide an improved stability of the load, in the transport position, the front portion is substantially horizontal thus holding the animal in a horizontal orientation rather than tilted as in a conventional cart arrangement.

Preferably, in the transport position, the front portion extends from the front edge in front of the front pair of wheels rearwardly to a position over the rear pair of wheels locating the animal substantially equally over both pairs of wheels for stability.

Preferably, in the transport position, the axis of the front pair of wheels is located at a position approximately midway along the front portion so that a center of gravity of material on the front portion is close to a vertical plane passing through the axis of the front pair of wheels allowing easy tilting of the trolley between the loading and transport positions. This reduces the load which the operator needs to lift to carry out the tilting action.

Preferably the rear portion extends from the front portion at an angle such that, in the loading position with the front edge on the floor surface, the rear portion stands substantially vertically upwardly from the front portion. This locates the winch vertically above the front edge to assist in easily pulling the animal onto the cradle. Preferably the rear portion thus extends from the front portion upwardly and rearwardly at an angle in the range 40 to 60 degrees.

Preferably the front and rear pairs of wheels are fixed against steering movements. That is they do not caster or steer allowing the cart to be more easily managed with larger wheels.

Preferably the front and rear pairs of wheels are fixed relative to the trolley frame against adjustment movement and against folding movement. Again therefore this provides a stable structure where the wheels are mounted in a simple fixed manner to provide an inexpensive construction with good rigidity.

Preferably the front and rear pairs of wheels have the axes thereof close together to allow skid steering by the operator using little guiding force. Thus preferably the front and rear pairs of wheels have the periphery thereof less than 12 inches and preferably less than 6 inches apart.

Preferably the front portion is substantially planar and more preferably the front and rear portions are each substantially planar and connected at an angle. This allows a simple construction formed by a frame covered by flat sheets of a suitable low friction material such as XX.

Preferably the rear portion has a rear edge thereof adjacent the handle.

Preferably there is provided an optional motor for forward and rearward driving movement of at least one of the front and rear pairs of wheels. This can assist the operator when the cart is heavily loaded for example to negotiate ramps. Preferably the motor is mounted under the front portion of the cradle. Preferably the motor connects drive to the wheels though a clutch such as a simple band clutch which applies drive from the motor by tensioning a connecting band. The clutch can be operated by a lever mounted at handle at a similar location to a switch for the motor.

Preferably the trolley carries a plurality of receptacles thereon for receiving tools. As the design of cart is very stable it can be easily wheeled by the operator around the barn and remains stable when released for the operator to move away to carry out a task. Thus it can readily carry at a suitable location tools which the operator needs allowing the operator to grab a tool, release the cart and move away from the cart to operate on an animal which needs attention. Thus the receptacles are mounted on the trolley frame at a location which avoids interferences with the loading of the animal on the cradle.

### BRIEF DESCRIPTION OF THE DRAWINGS

One embodiment of the invention is described below in conjunction with the accompanying drawings in which:

FIG. 1 is an isometric view of a cart according to the invention.

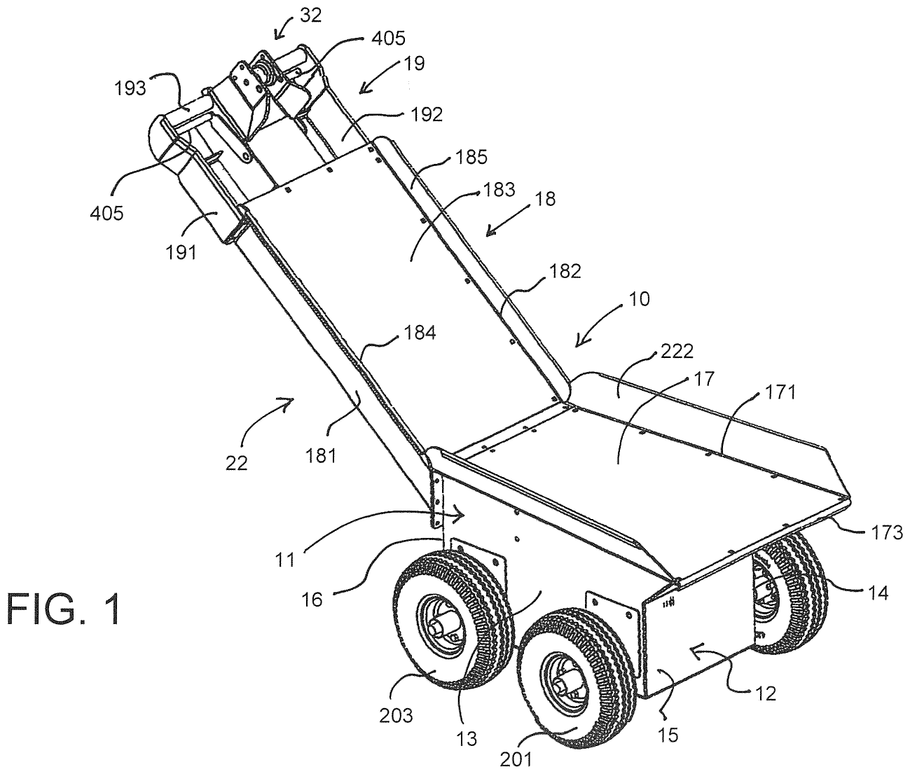

FIG. 2 is a side elevational view of the cart of FIG. 1 in a transport position with a load carried on the cradle.

FIG. 3 is a side elevational view of the cart of FIG. 1 shown in the loading position with the front edge tilted into engagement with the floor.

FIG. 4 is a top plan view of the cart of FIG. 1.

### DETAILED DESCRIPTION

A trolley or cart 10 for use by a worker in animal husbandry includes a trolley frame 11 which is mounted on ground wheels so that the worker can take the trolley with the worker around a barn containing the animals being raised. The trolley is primarily arranged for extracting dead animals which die occasionally in a large barn of animals for various reasons. Also the cart can be used for transporting manual tools by the worker of various types known to person in the industry for operating on the animals or carrying out various functions in the animal husbandry.

The frame 11 is formed of sheet metal to form a front box section 12 including side walls 13 and 14 and front and rear walls 15 and 16. On top of the box section 12 is provide a top panel 17 which is generally horizontal and extends across the top to side edges 171 and 172. A front edge 173 of the panel extends across the full width between the sides. The front edge includes a curled edge 174 of the sheet metal which prevents presentation of a sharp edge and reduces warping.

The frame 111 further includes an inclined rear section 18 defined by depending parallel sides 181 and 182 each connected at its lower end to a rear edge of a respective side wall 13, 14. Across an upper edge of the side walls is provided an inclined rear panel 183.

At an upper edge of the rear section 18 is provided a handle section 19 including two side beams 191 and 192 and a cross rail 193 forming a handle.

The frame 11 is mounted on four wheels 20 connected to the frame 11 at the box section 12 for supporting the frame from a floor surface for rolling movement in a direction longitudinally of the frame. The frame can thus move forwardly in the direction of the wheels guided by the operator holding the handle. The four wheels include a front pair 201 of wheels carried on a front axle 202 and rotatable about a front axis at the axle. The axle is mounted on the box section 12 adjacent the front of the box section. The wheels 20 include a rear pair of wheels 203 mounted on a rear axle 204 rotatable about a rear axis. The rear wheels are mounted also on the box section adjacent a rear edge of the box section. The box section and the four wheels thus form a stable structure carried stably on the four wheels so as to be easily maneuverable by the worker at the handle rail 193. The rear handle 193 is thus manually graspable for guiding the trolley by the worker pulling side to side as required to guide the steering and pushing and pulling in the longitudinal direction as required.

A cradle 22 is formed on the frame for receiving a body of a deceased animal. The cradle is defined by the top panel 17 and the inclined rear panel 183. The cradle includes upstanding side panels 221 and 222 each along a respective side edge of the top panel 17 and inclined upwardly and outwardly to confine a load on the top panel from moving to the side. The cradle includes upstanding side panels 184 and 185 each along a respective side edge of the rear inclined panel 183 and inclined upwardly and outwardly.

The cradle thus formed by the surfaces and the inclined side surfaces forms a channel extending longitudinally of the trolley frame from a rear end adjacent the handle 193 to a forward end including a transverse front edge 173 over which the body can slide for storage on the cradle. The cradle thus the front portion 17 extending rearwardly from the front edge 173 over the first and second pairs of wheels 201, 203.

A winch arrangement 30 is provided at or adjacent the rear end 19 for pulling an elongate flexible member or cable 31 for attachment by a suitable coupling to a leg or neck of the animal to pull the animal onto the cradle. The winch arrangement 30 includes an electric winch 33 mounted on the frame underneath the inclined rear section 18 in front of the handle and a pulley 32 at the center of the handle 193. The cable 31 thus includes a portion 34 extending from the winch over the pulley so that a main portion of the cable extends along the rear portion of the cable in a direction generally parallel thereto so as to pull the load over the front edge 173 onto the cradle.

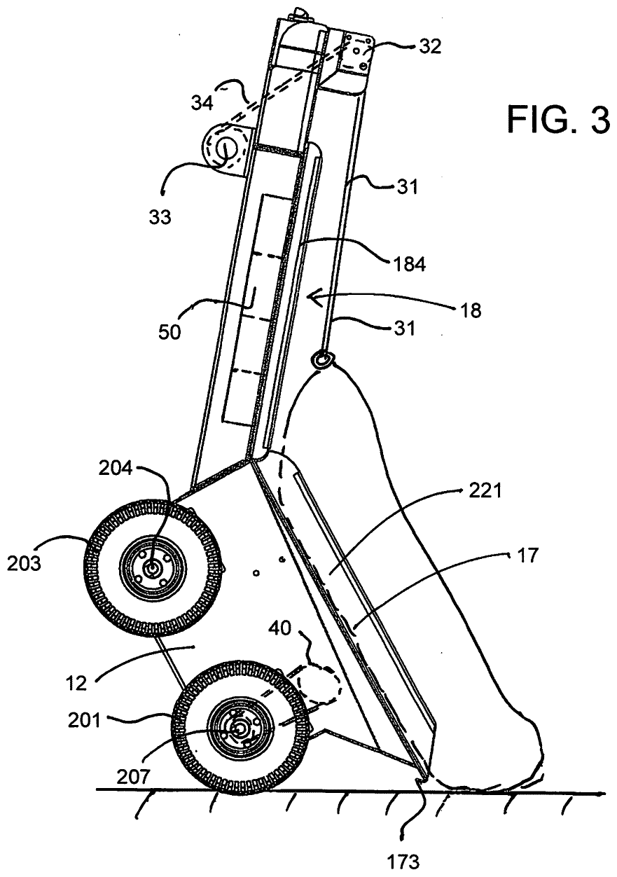

While the trolley can ride stably on the trolley frame on the two pairs of wheels for maneuvering in the transport position, the cradle is pivotal on the front pair of wheels 201 about the front axis from the loading position to the transport position shown in FIG. 3. In the loading position, the transverse front edge 173 is in contact with the floor surface for sliding movement of the animal over the front edge and the rear pair 203 of wheels are raised from the floor surface. Thus, in the transport position, the transverse front edge 173 is raised from the floor surface, the rear pair of wheels 203 are returned into contact with the floor surface and the front portion extends rearwardly from the front edge over the front pair of wheels to the rear pair of wheels to be stably supported by both the front and rear pairs of wheels.

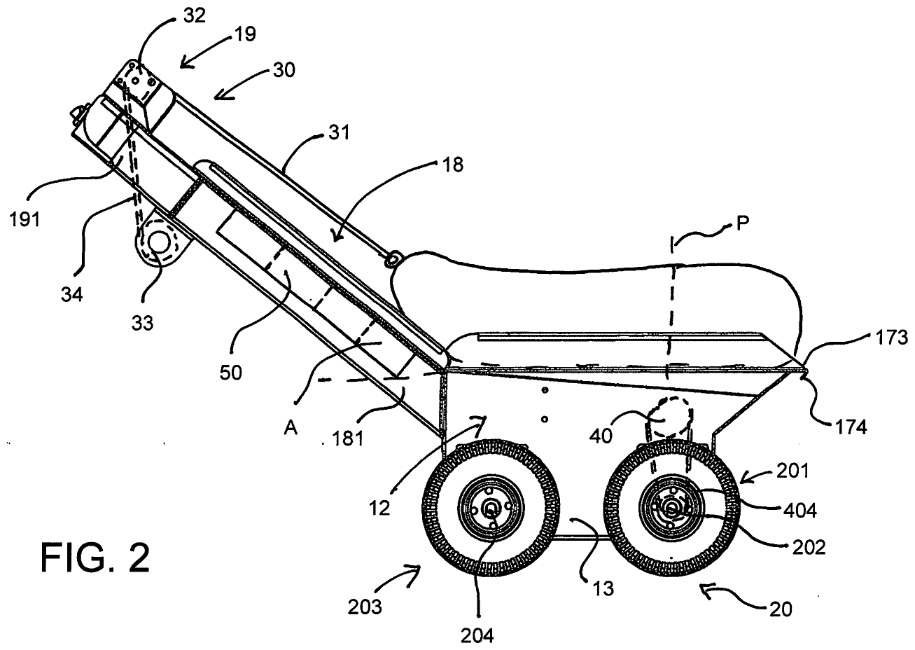

As shown in FIG. 2, in the transport position, the front portion 17 is substantially horizontal and extends from the front edge 173 in front of the front pair 201 of wheels rearwardly to a position over the rear pair of wheels 203. Thus in this transport position, the axle 202 of the front pair of wheels is located at a position approximately midway along the front portion or slightly forward thereof so that a center of gravity of material on the front portion is close to or just behind a vertical plane P passing through the axle 202 of the front pair of wheels allowing easy tilting of the trolley between the loading and transport positions. In this way the worker can readily apply the required lifting force to the handle to cause this movement even when the load on the cradle is relatively heavy.

As shown in the lading position of FIG. 3, the rear portion 18 extends from the front portion 17 at an angle such that, in the loading position with the front edge 173 on the floor surface, the rear portion 18 stands substantially vertically upwardly from the front portion. This is obtained in that the rear portion 18 extends from the front portion 17 upwardly and rearwardly at an angle A in the range 40 to 60 degrees.

As the intention is that the trolley is easily steered by the worker applying forces left and right, the front and rear pairs of wheels are fixed against steering movements. Also the front and rear pairs of wheels are fixed relative to the trolley frame 12 against adjustment movement and against folding movement. The wheels are mounted on the axles thereof which are thus fixed to the box structure. This makes a simple stable structure which can be released by the worked when the worker needs to carry out a task and the trolley will remain stable.

In order to provide the simple skid steering action, the front and rear pairs of wheels have the axles 202 and 204 thereof close together to allow skid steering. That is the front and rear pairs of wheels have the periphery of the wheels thereof less than 12 inches and preferably less than 6 inches apart.

The front and rear portions 17, 18 are each substantially planar and connected at the angle A. This forms a simple inexpensive structure.

Within the box section 12 mounted under the front portion of the cradle there is provided a motor 40 for forward and rearward driving movement of the front pair 201 of wheels. The motor can thus be driven in two directions under control of a toggle switch 401 at the handle which operates on a motor control 402 through a connecting line 406. A power switch 403 can also be provided to turn the motor on and off as required. The motor 40 connects drive to the front axle 202 of the wheels though a clutch 404. One simple form of clutch which can be used is a band clutch which applies drive from the motor by tensioning a connecting band. The clutch 404 for the drive motor 40 is operated by a lever 405 mounted at handle. The lever 405 comprises a rod parallel to the handle 193 so that the worker with hands on the handle 193 can grasp the rod 405 and pull on that rod and pull it toward the handle. This communicates to the motor control operating the clutch 404 through a connecting line 407. The operator can thus turn on the motor in forward or rearward direction as required and can control the power applied to the wheels from the motor through the clutch by simply pulling on the handle lever 405. Also when the motor is not running the action of pulling on the handle lever 405 will connect the inertia of the motor to the wheels to provide a braking action.

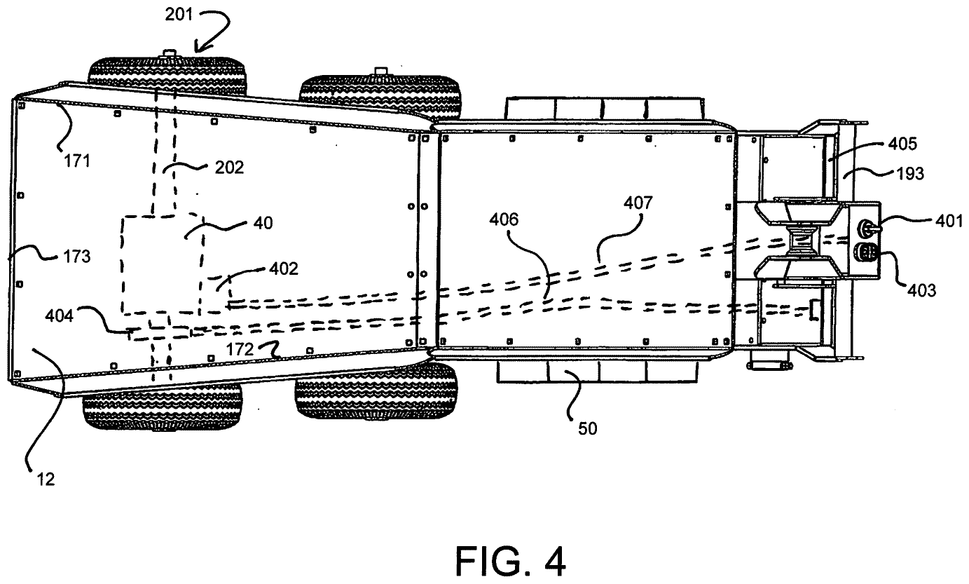

As shown in the top plan view of FIG. 4, the front position of the cradle has sides 171 and 172 which converge gradually from the front edge 173 to the bottom of the rear position. Thus the box section 12 also converges rearwardly and the rear pair of wheels 203 mounted thereon are slightly narrower than the front pair of wheels.

As the trolley is also intended to be a utility device to carry tools for use by the worked during the husbandry, the trolley carries a plurality of receptacles 50 thereon for receiving the tools. These can form a simple row of cups along the trolley in front of the handle along the sides of the rear portion. Other mounting locations can also be provided. The receptacles are mounted on the trolley frame at a location which avoids interference with the loading of the animal on the cradle.

1. A trolley for use in animal husbandry comprising:
a trolley frame;
four wheels connected to the frame for supporting the frame from a floor surface for movement in a direction longitudinally of the frame, the four wheels including a front pair of wheels rotatable about a front axis and a rear pair of wheels rotatable about a rear axis;
a rear handle connected to the frame which is manually graspable for guiding the trolley;
a cradle on the frame for receiving a body of a deceased animal;
the cradle extending longitudinally of the trolley frame from a rear end adjacent the handle to a forward end including a transverse front edge over which the body can slide for storage on the cradle;
the cradle including a front portion extending rearwardly from the front edge over the first and second pairs of wheels;
the cradle including a rear portion at an angle to the front portion so as to extend upwardly and rearwardly from the front portion to the rear end adjacent the rear handle;
a winch arrangement at or adjacent the rear end for pulling an elongate flexible member for attachment to the animal to pull the animal onto the cradle;
the trolley frame and cradle being pivotal on the front pair of wheels about the front axis from a loading position to a transport position;
wherein, in the loading position, the transverse front edge is in contact with the floor surface for sliding movement of the animal over the front edge and the rear pair of wheels are raised from the floor surface;
wherein, in the transport position, the transverse front edge is raised from the floor surface, the rear pair of wheels are in contact with the floor surface and the front portion extends rearwardly from the front edge over the front pair of wheels to the rear pair of wheels so that the front portion is stably supported by both the front and rear pairs of wheels.

2. The trolley according to claim 1 wherein, in the transport position, the front portion is substantially horizontal.

3. (canceled)

4. The trolley according to claim 1 wherein, in the transport position, the axis of the front pair of wheels is located at a position midway along the front portion so that a center of gravity of material on the front portion is close to a vertical plane passing through the axis of the front pair of wheels allowing easy tilting of the trolley between the loading and transport positions.

5. The trolley according to claim 1 wherein the rear portion extends from the front portion at said angle thereto such that, in the loading position with the front edge on the floor surface, the rear portion stands substantially vertically upwardly from the front portion.

6. The trolley according to claim 1 wherein the rear portion extends from the front portion upwardly and rearwardly at said angle in the range 40 to 60 degrees.

7. The trolley according to claim 1 wherein the front and rear pairs of wheels are fixed against steering movements.

8. (canceled)

9. (canceled)

10. (canceled)

11. The trolley according to claim 1 wherein the front portion is substantially planar.

12. The trolley according to claim 1 wherein the rear portion is substantially planar.

13. The trolley according to claim 1 wherein the rear portion has a rear edge thereof adjacent the handle.

14. The trolley according to claim 1 wherein there is provided a motor for forward and rearward driving movement of at least one of the front and rear pairs of wheels.

15. The trolley according to claim 14 wherein the motor is mounted under the front portion of the cradle.

16. The trolley according to any claim 14 wherein the motor applies drive to the wheels though a clutch operated by a lever mounted at the handle.

17. (canceled)

18. (canceled)

19. The trolley according to claim 1 wherein the trolley carries a plurality of receptacles thereon for receiving tools.

20. The trolley according to claim 19 wherein the receptacles are mounted on the trolley frame at a location which avoids interference with the loading of the animal on the cradle.

21. A trolley for use in animal husbandry comprising:
a trolley frame;
four wheels connected to the frame for supporting the frame from a floor surface for movement in a direction longitudinally of the frame, the four wheels including a front pair of wheels rotatable about a front axis and a rear pair of wheels rotatable about a rear axis;
a rear handle connected to the frame which is manually graspable for guiding the trolley;
a cradle on the frame for receiving a body of a deceased animal;
the cradle extending longitudinally of the trolley frame from a rear end adjacent the handle to a forward end including a transverse front edge over which the body can slide for storage on the cradle;
the cradle including a front portion extending rearwardly from the front edge over the first and second pairs of wheels;
the cradle including a rear portion at an angle to the front portion so as to extend upwardly and rearwardly from the front portion to the rear end adjacent the rear handle;
a winch arrangement at or adjacent the rear end for pulling an elongate flexible member for attachment to the animal to pull the animal onto the cradle;
the trolley frame and cradle being pivotal on the front pair of wheels about the front axis from a loading position to a transport position;
wherein, in the loading position, the transverse front edge is in contact with the floor surface for sliding movement of the animal over the front edge and the rear pair of wheels are raised from the floor surface;
wherein, in the loading portion, the rear portion extends from the front portion at said angle thereto such that, with the front edge on the floor surface, the rear portion stands substantially vertically upwardly from the front portion;
wherein, in the transport position, the transverse front edge is raised from the floor surface, the rear pair of wheels are in contact with the floor surface, the front portion is substantially horizontal and the front portion extends rearwardly from the front edge over the front pair of wheels at least to the axis of the rear pair of wheels so that the front portion is stably supported by both the front and rear pairs of wheels.

22. The trolley according to claim 21 wherein the front and rear pairs of wheels are fixed against steering movements.

23. A trolley for use in animal husbandry comprising:
a trolley frame;
four wheels connected to the frame for supporting the frame from a floor surface for movement in a direction longitudinally of the frame, the four wheels including a front pair of wheels rotatable about a front axis and a rear pair of wheels rotatable about a rear axis;
a rear handle connected to the frame which is manually graspable for guiding the trolley;
a cradle on the frame for receiving a body of a deceased animal;
the cradle extending longitudinally of the trolley frame from a rear end adjacent the handle to a forward end including a transverse front edge over which the body can slide for storage on the cradle;
the cradle including a front portion extending rearwardly from the front edge over the first and second pairs of wheels;
the cradle including a rear portion at an angle to the front portion so as to extend upwardly and rearwardly from the front portion to the rear end adjacent the rear handle;
a winch arrangement at or adjacent the rear end for pulling an elongate flexible member for attachment to the animal to pull the animal onto the cradle;
the trolley frame and cradle being pivotal on the front pair of wheels about the front axis from a loading position to a transport position;
wherein, in the loading position, the transverse front edge is in contact with the floor surface for sliding movement of the animal over the front edge and the rear pair of wheels are raised from the floor surface;
wherein, in the transport position, the transverse front edge is raised from the floor surface, the rear pair of wheels are in contact with the floor surface;
and wherein the front portion is mounted on a box section underneath the front portion with the axes of both the front and rear pairs of wheels extending through the box section so that the front portion is stably supported in the transport position by both the front and rear pairs of wheels.

24. The trolley according to claim 23 wherein, in the transport position, the front portion is substantially horizontal.

25. The trolley according to claim 23 wherein the rear portion extends from the front portion at said angle thereto such that, in the loading position with the front edge on the floor surface, the rear portion stands substantially vertically upwardly from the front portion.

26. The trolley according to claim 23 wherein the front and rear pairs of wheels fixed in the box section against steering movements.
